(19) United States
(12) Patent Application Publication
(10) Pub. No.: US 2024/0315392 A1
(43) Pub. Date: Sep. 26, 2024

(54) LATTICE STRUCTURES

(71) Applicant: HEWLETT-PACKARD DEVELOPMENT COMPANY, L.P., Spring, TX (US)

(72) Inventors: Wei HUANG, Palo Alto, CA (US); Jun ZENG, Palo Alto, CA (US)

(73) Assignee: HEWLETT-PACKARD DEVELOPMENT COMPANY, L.P., Spring, TX (US)

(21) Appl. No.: 18/698,643

(22) PCT Filed: Oct. 4, 2021
(86) PCT No.: PCT/US2021/053430

§ 371 Date: Apr. 4, 2024

(51) Int. Cl. A43B 13/18; A43B 13/12; B22F 3/11; B33Y 50/00; B33Y 80/00

(52) U.S. Cl. CPC A43B 13/186; A43B 13/125; B22F 3/1115; B33Y 50/00; B33Y 80/00

(57) ABSTRACT

Examples of structures are described herein. In some examples, a structure includes a lattice of posts. In some examples, the lattice of posts forms an opening between the posts. In some examples, the structure includes an appendage attached to a post of the posts. In some examples, the appendage extends over the opening. In some examples, the appendage is non-load bearing.

### BACKGROUND

Different materials have different mechanical properties. For example, different foams, plastics, polymers, metals, cloths, etc., exhibit different properties under compression, tension, torsion, flexion, etc. For instance, different materials may deform differently and/or exhibit different tolerances when under a mechanical load. Materials may be utilized to manufacture objects according to the properties of the materials and anticipated use of the objects.

### BRIEF DESCRIPTION OF THE DRAWINGS

FIG. 1 is a diagram illustrating an example of a structure including a lattice;

FIG. 2A is a diagram illustrating a side view of an example of a midsole;

FIG. 2B is a diagram illustrating an enlarged side view of a region of the example of the midsole of FIG. 2A;

FIG. 2C is a diagram illustrating an example of the region of the midsole of FIG. 2B under a mechanical load;

FIG. 3 is a diagram illustrating an example of a framework including a lattice;

FIG. 4 is a diagram illustrating an example of a lattice in accordance with some of the techniques described herein;

FIG. 5 is a flow diagram illustrating an example of a method for manufacturing a structure; and

FIG. 6 is a block diagram of an example of an apparatus that may be used to manufacture a structure or structures described herein.

### DETAILED DESCRIPTION

A lattice is an arrangement of a member or members (e.g., branches, beams, joists, columns, posts, rods, etc.). For example, a lattice may be structured along one dimension, two dimensions, and/or three dimensions. Examples of a lattice may include posts, two-dimensional grids, three-dimensional grids, etc. In some examples, a lattice may be structured in a repetitive pattern or in a non-repetitive arrangement. In some examples, a lattice includes members disposed in a crosswise manner. For instance, two members of a lattice may intersect at a diagonal, perpendicular, or oblique (e.g., non-perpendicular and non-parallel) angle. Lattices may provide wide ranges of properties while having the same material composition. Lattices may exhibit unique mechanical properties that are not exhibited by some solid materials.

Lattices may be utilized in many fields for their mechanical properties. In some cases, openings (e.g., spaces between posts, apertures, etc.) in lattices may permit foreign objects into the structures, which can affect the mechanical properties and/or aesthetics of the lattices. In some cases, the foreign object(s) may be difficult to remove. For example, small rocks can enter lattice shoe midsoles, which may affect the mechanical performance of the midsoles and/or may cause discomfort to the wearer.

Some examples of the structures described herein include appendages. An appendage is an extension and/or limb of a structure. In some examples, an appendage(s) may be utilized to reduce and/or prevent an external object(s) from entering a lattice. In some examples, an appendage may be added to a post (an outermost post, an outer edge, a boundary cell, etc.) of a lattice (e.g., of an open-cell lattice) to make an opening smaller. In some examples, an appendage may be connected to an external region or an internal region of a lattice. For instance, appendages may be connected to external regions (e.g., outer boundary region(s)) and/or internal regions (e.g., inner region(s)) of the lattice. In some examples, appendages of a same size and/or appendages of different sizes may be included in a structure.

In some examples, an appendage or appendages may be non-load bearing or zero-load. A non-load bearing appendage or zero-load appendage is an appendage that does not bear a load of the lattice and/or that does not affect a load bearing property of a lattice. For instance, a non-load bearing appendage may not bear any target load for a lattice. In some examples, appendages may be shaped and/or connected to a lattice without contacting the lattice except at a connection region(s). In some examples, a mechanical property or properties of a lattice may not be affected by a non-load bearing appendage.

In some examples, a lattice may be manufactured by three-dimensional (3D) printing. Some examples of 3D printing that may be utilized to manufacture some examples of the lattices described herein may include Fused Deposition Modeling (FDM), Multi-Jet Fusion (MJF), Selective Laser Sintering (SLS), 3D Binder Jetting, Stereolithography (SLA), Selective Laser Melting (SLM), Electron Beam Melting (EBM), Metal Jet Fusion, Powder Jet Fusion, metal binding printing, liquid resin-based printing, etc.

In some examples, additive manufacturing may be used to manufacture 3D objects (e.g., geometries, lattices, etc.). Some examples of additive manufacturing may be achieved with 3D printing. For example, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150=170 microns for 150 dots per inch (dpi), 490 microns for 50 dpi, 2 mm, 4 mm, etc. The term “voxel level” and variations thereof may refer to a resolution, scale, or density corresponding to voxel size.

Some examples of the geometries and/or structures (e.g., lattices) described herein may be produced by additive manufacturing. For instance, some examples may be manufactured with plastic(s), polymer(s), semi-crystalline material(s), metal(s), etc. Some additive manufacturing techniques may be powder-based and driven by powder fusion. Some examples of the geometries and/or structures (e.g., lattices) described herein may be manufactured with area-based powder bed fusion-based additive manufacturing, such as MJF, Metal Jet Fusion, metal binding printing, SLM, SLS, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object (e.g., structure, geometry, lattice, etc.). For example, agents (e.g., fusing agent, detailing agent, etc.) may be selectively deposited to control voxel-level energy deposition, which may trigger a phase change and/or solidification for selected voxels.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

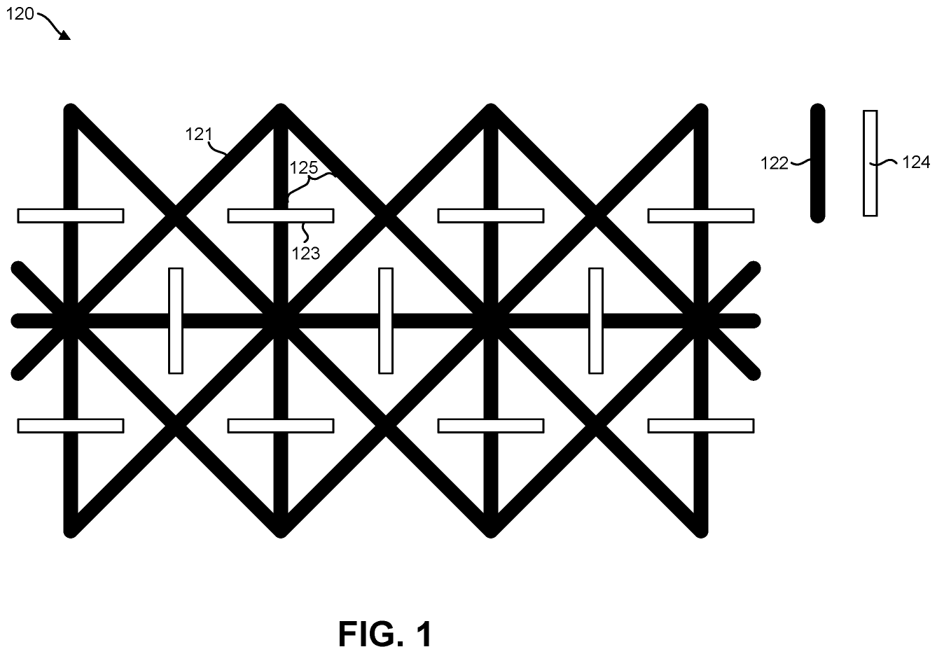

FIG. 1 is a diagram illustrating an example of a structure 120 including a lattice 121. The lattice 121 includes posts 122. In some examples, posts may intersect at a diagonal, perpendicular, or oblique (e.g., non-perpendicular and non-parallel) angle. In the example of FIG. 1, the posts 122 of the lattice 121 intersect at 90° and 45° angles. In other examples, the posts of a lattice may intersect at a different angle or angles (e.g., 15°, 30°, 45°, 70°, 85°, 95°, 110°, 135°, etc.). The posts of a lattice may form an opening or opening between the posts. For instance, some of the posts 122 of the lattice 121 form an opening 125 between posts.

The structure 120 may include appendages 124. For example, the structure 120 includes an appendage 123 attached to a post of the posts 122. For instance, an appendage 123 may be manufactured to be attached to a post at an attachment location or point. In some examples, the attachment may be achieved using the same material from which the post and/or appendage are manufactured (e.g., the attachment may be 3D printed), or may be achieved with another technique (e.g., using glue, a screw, fastener, clip, etc.). In some examples, an appendage or appendages may have a same or different thickness than a post or posts of a lattice. In some examples, appendages may be attached to vertical posts, horizontal posts, and/or diagonal posts of a lattice. In the example of FIG. 1, the appendages 124 are attached to vertical and horizontal posts of the lattice 121.

In some examples, an appendage may be attached at a span between nodes of a post. A node is an intersection and/or connection between posts. A span is a post or a portion of a post between nodes. In the example of FIG. 1, the appendage 123 is attached to a post at a center of a span between nodes of a post. In some examples, an appendage may be attached to a span at an off-center location. In some examples, an appendage may be attached to a span at multiple locations (e.g., center and/or off-center locations). In some examples, an appendage may be attached at a node (e.g., attached to multiple posts at an intersection of the posts) of a lattice.

In some examples, an appendage (e.g., appendage 123) may be attached to a post, where the post is an exterior post at an outer edge of a structure (e.g., structure 120). For instance, the appendage 123 may be attached to an outside of a post and/or may be attached to an outer layer of posts of the structure 120. In some examples, an appendage may be attached to an inside of a post (e.g., inside of a span and/or inside of a node) and/or may be attached to an interior post (e.g., interior span and/or interior node).

The appendage 123 extends over the opening 125. For example, the appendage 123 extends partially over the opening 125. In some examples, an appendage may extend fully across an opening. For instance, an appendage may extend across an opening to another post on another side of the opening without being attached to the other post. In some examples, an appendage may not completely cover an opening. For instance, a structure may include a space or spaces (in a dimension or dimensions) between an appendage and a post or posts of the structure. In some examples, an appendage reduces a size of an opening. For instance, the appendage 123 reduces a size of the opening 125 between posts of the lattice 121.

The appendage 123 is non-load bearing. For instance, the appendage 123 is arranged to not bear (e.g., support, resist, etc.) a load of downward pressure on the lattice 121. In some examples, a non-load bearing appendage (e.g., appendage 123) may not deform when a structure (e.g., structure 120) is under a mechanical load. Examples of deformation may include changes in size, changes in shape, bending, stretching, etc. In some examples, a size (and/or shape) of the appendage 123 may not deform when the structure 120 is under a mechanical load. For instance, when the structure 120 is under a mechanical load of downward pressure, the posts 122 may deform (e.g., compress, stretch, bend, etc.), whereas the appendage 123 may not deform (e.g., the appendage 123 may maintain shape and/or size, may not change size, may not change shape, may not compress, may not stretch, and/or may not bend, etc.). In some examples, an appendage (e.g., appendage 123) may move (e.g., shift, translate, rotate, change position, etc.), but may not deform (e.g., may maintain dimensionality).

In some examples, an appendage may include an unattached end. For instance, the appendage 123 is attached to a post at a location and includes two unattached ends.

In some examples, an appendage may extend over an opening or multiple openings. For instance, the appendage 123 extends over two openings on different sides of a post. In some examples, an appendage may extend over an opening on one side of a node or may extend over multiple openings on different sides of a node. In some examples, an appendage may traverse over a post or node (between openings, for instance) at an attachment location.

In some examples, an appendage may be on a different level, elevation, and/or plane than a post or posts. For instance, the appendage 123 may be situated on a level above (e.g., on top of) the posts 122 to avoid interfering with the posts 122 during post deformation (e.g., when the structure 120 is under load).

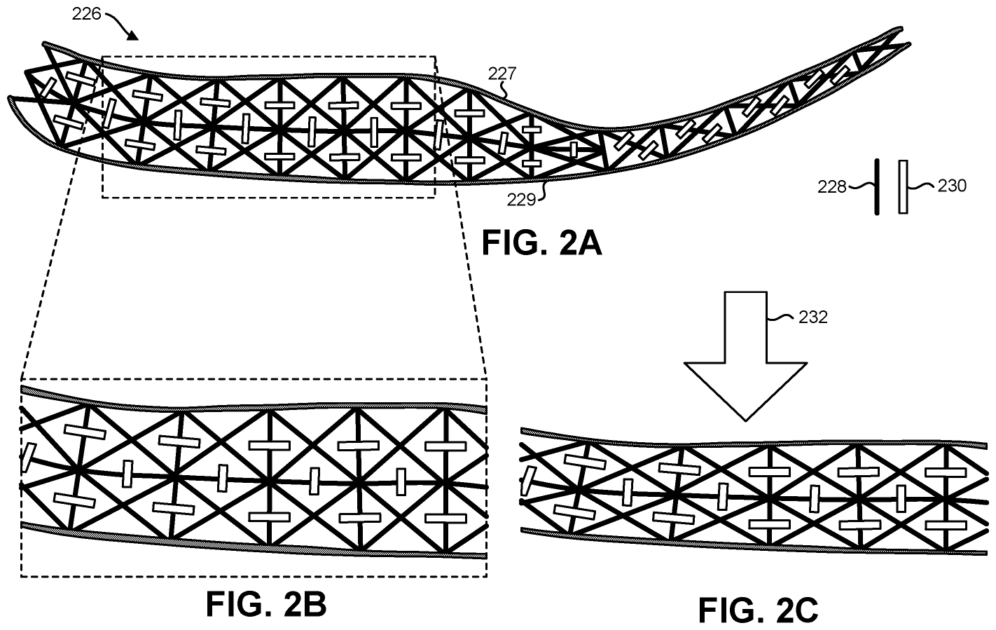

FIG. 2A is a diagram illustrating a side view of an example of a midsole 226. FIG. 2B is a diagram illustrating an enlarged side view of a region of the example of the midsole 226 of FIG. 2A. FIG. 2C is a diagram illustrating an example of the region of the midsole 226 of FIG. 2B under a mechanical load 232. FIG. 2A, FIG. 2B, and FIG. 2C will be described together.

The midsole 226 may be an example of the structure 120 described in relation to FIG. 1. For instance, the midsole 226 includes a lattice of posts 228. In some examples, the posts 228 may be examples of the posts 122 described in relation to FIG. 1. The midsole 226 also includes appendages 230 attached to some of the posts 228. The appendages 230 may be examples of the appendages 124 described in relation to FIG. 1.

In some examples, the midsole 226 includes an upper surface 227 (e.g., ceiling) and/or a lower surface 229 (e.g., floor). In some examples, the upper surface 227 and/or the lower surface 229 may be manufactured from the same material as the posts 228 and/or appendages 230. For instance, the upper surface 227 and/or the lower surface 229 may be printed with the posts 228 and/or appendages 230. In some examples, the upper surface 227 and/or the lower surface 229 may be manufactured from a different material from the posts 228 and/or appendages 230.

In some examples, the midsole 226 may be a component of a shoe including a lattice to provide support and/or cushioning to a wearer of the shoe. The appendages 230 are examples of zero-load appendages to reduce and/or prevent the intake of external objects (e.g., rocks, pebbles, foreign objects, etc.). In this example, the lattice includes posts and nodes in the midsole 226. The appendages 230 may be strips attached to spans of the posts 228 on the outer edge (e.g., boundary). In some examples, the appendages 230 may be printed as portions of the midsole 226.

In some examples, the lengths and positions of the appendages 230 may be arranged such that, when no load is applied on the midsole 226, the appendages 230 may not contact the lattice except at the connection locations, as illustrated in FIG. 2B. When a load 232 (e.g., maximum target load) is applied on the midsole 226, the appendages 230 may not contact the lattice except at the connection locations. For instance, the connections between the lattice and the appendages 230 may be maintained under a load 232. Accordingly, the appendages 230 do not bear (e.g., support, oppose, resist, etc.) the load 232. In some examples, the appendages 230 may have reduced, minimal, or no influence on the mechanical properties of the midsole 226 for a range of mechanical load 232. For instance, a range of a mechanical load may be between zero load and a maximum target load (e.g., maximum weight and/or pressure designed to be supported by the midsole 226) in a direction (e.g., downward). Because the appendages 230 reduce the openings of the cells of the lattice, foreign objects (e.g., rocks) of larger sizes may be prevented from entering the lattice.

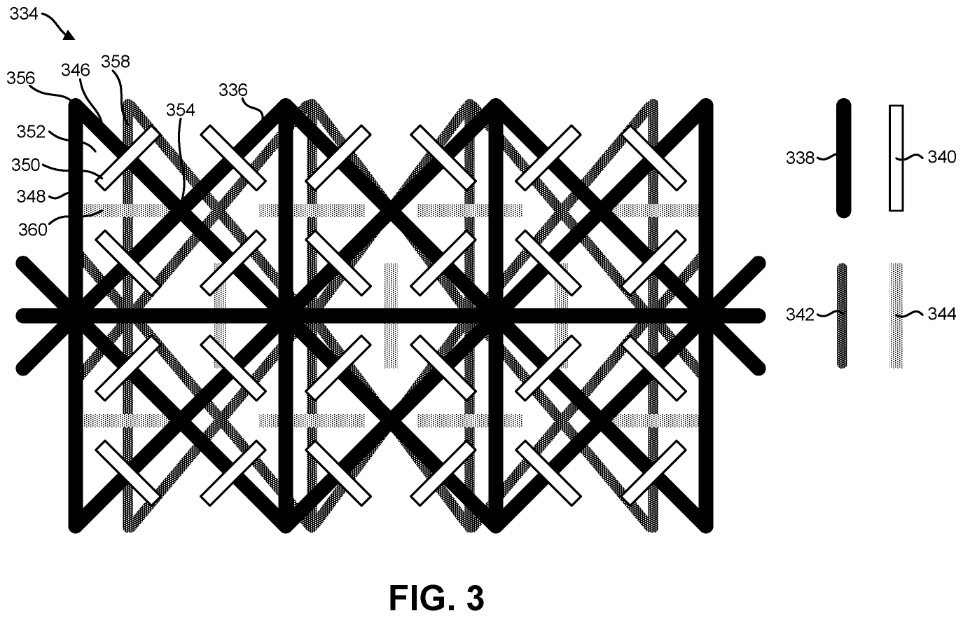

FIG. 3 is a diagram illustrating an example of a framework 334 including a lattice 336. The framework 334 may be an example of the structure 120 described in relation to FIG. 1. The lattice 336 includes a plurality of posts 338 and a plurality of nodes at post intersections. The lattice 336 also includes appendages 340.

In some examples, the framework 334 includes an appendage 350. The appendage 350 may extend over an opening 352 between a first post 346 and a second post 348 of the plurality of posts 338. The appendage 350 may be attached to the first post 346 at a span between adjacent nodes (e.g., a first node 354 and a second node 356). An end of the appendage 350 may be unattached. In some examples, the framework 334 may be included in a midsole or another structure (e.g., insole, tire, shock absorber, cushion, pillow, etc.).

In some examples, an outer edge of the framework 334 may be open. For instance, the plurality of posts 338 may be disposed along an outer edge or boundary of a structure. The outer edge may include openings between the plurality of posts 338.

In some examples, the lattice 336 may include a plurality of interior posts 342. For instance, the interior posts 342 may be situated within a structure (e.g., behind an outer edge of the structure). For instance, the lattice 336 may include an interior post 358. In some examples, the lattice 336 may include a plurality of interior appendages 344. For instance, the lattice 336 may include a second appendage 360 attached to the interior post 358. In the example of FIG. 3, the appendage 350 is attached to the post 346 (e.g., exterior post) at a first span position, and the second appendage 360 is attached to the interior post 358 at a second span position that is different from the first span position. For instance, the second span position may be located on a different span of the plurality of interior posts 342 than the first span position of the plurality of posts 338. In some examples, the second span position may be located at a different second distance from a second node than the first span position at a first distance from a respective (e.g., corresponding) first node. Using different (e.g., staggered) locations for appendages on different post layers (and/or on front and back sides of posts) may provide additional opening blockage.

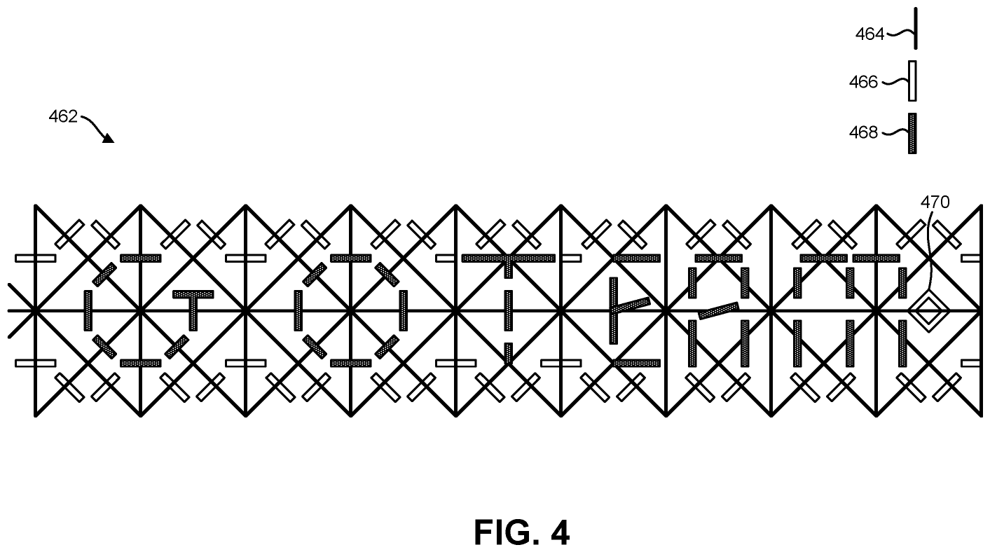

FIG. 4 is a diagram illustrating an example of a lattice 462 in accordance with some of the techniques described herein. The lattice 462 may be an example of the lattice 121 described in relation to FIG. 1, an example of the lattice described in relation to FIG. 2, and/or an example of the lattice 336 described in relation to FIG. 3. In this example, the lattice 462 includes posts 464 and appendages.

In this example, a first set of appendages 468 depicts information. In some examples, appendages may be arranged to convey information. For instance, the first set of appendages 468 depicts a message “GO TEAM.” Other arrangements of appendages may convey other information and/or messages in some examples. For instance, a set of appendages may be manufactured to indicate information that can be displayed on a side of a midsole. In some examples, an appendage may not have a same orientation as a post that the appendage is attached to. For instance, a length of an appendage may not completely overlap with a post to avoid thickening the post and/or to avoid significantly changing the mechanical properties of a post. In some examples, an appendage may appear to overlap with a post due to a viewpoint, but may be oriented differently from the post in a dimension or dimensions.

In this example, the first set of appendages 468 is disposed on outside surfaces of the posts 464. In this example, a second set of appendages 466 is disposed on inside surfaces (e.g., backs) of the posts 464. In some examples, different sets of appendages may be manufactured in different colors and/or shades to convey information. For instance, different colors may indicate appendages that convey information and/or appendages that do not convey information.

The example of FIG. 4 also illustrates an example of an appendage 470 (e.g., a non-load bearing appendage) with multiple connection locations. For instance, the appendage 470 is attached to a span at two locations. In some examples, one, two, three, or more attachment locations may be utilized.

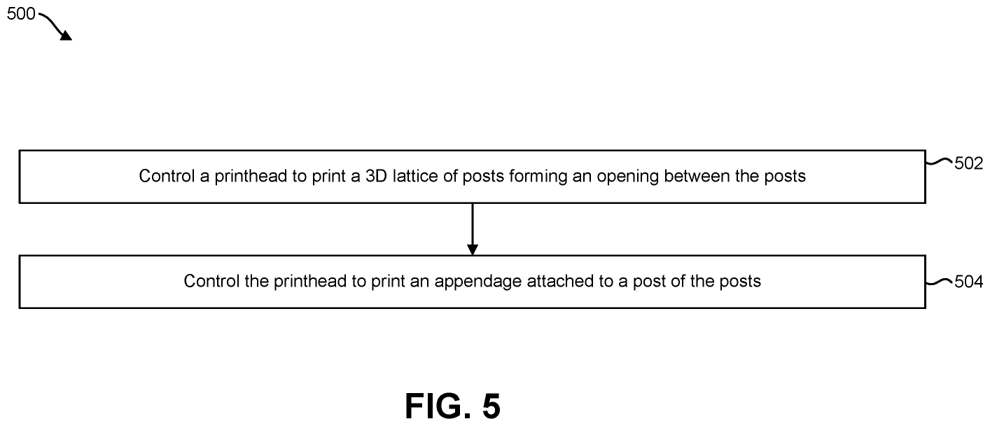

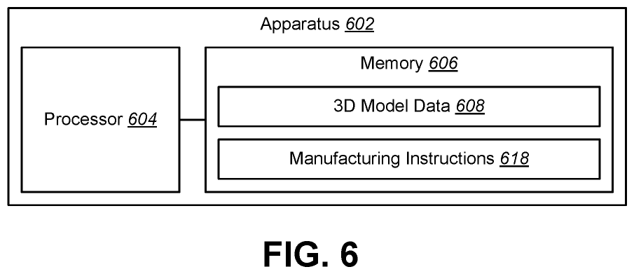

FIG. 5 is a flow diagram illustrating an example of a method 500 for manufacturing a structure. The method 500 and/or an element or elements of the method 500 may be performed by an apparatus (e.g., electronic device). For example, the method 500 may be performed by the apparatus 602 described in connection with FIG. 6.

The apparatus may control 502 a printhead to print a 3D lattice of posts forming an opening between the posts. For instance, the apparatus may be a 3D printer and/or may send instructions to a 3D printer to print the 3D lattice. The lattice 336 described in relation to FIG. 3 may be an example of a 3D lattice. In some examples, the apparatus may utilize a geometrical model (e.g., computer-aided design (CAD) file(s), 3D manufacturing format (3MF) file(s), etc.) that specifies the shape (e.g., mesh, voxels, etc.) of the 3D lattice. The apparatus may control 502 the printhead to print (e.g., extrude agent, glue, etc.) to a 3D region(s) indicated by the shape of the 3D lattice. In some approaches (e.g., MJF), the 3D region(s) may be printed with fusing agent and fused using a thermal lamp to solidify the first 3D lattice. In some approaches (e.g., Metal Jet Fusion), the 3D region(s) may be printed with binding agent (e.g., glue) to form a precursor object (e.g., “green part”). The precursor object may be heated in an oven to solidify the 3D lattice.

The apparatus may control 504 a printhead to print an appendage attached to the post of the posts. In some examples, the appendage extends over the opening. In some examples, the appendage is non-load bearing. For instance, the apparatus may be a 3D printer and/or may send instructions to a 3D printer to print a second 3D lattice. In some examples, the apparatus may utilize a geometrical model (e.g., CAD file(s), 3MF file(s), etc.) that specifies the shape (e.g., mesh, voxels, etc.) of the appendage(s). The apparatus may control 502 the printhead to print (e.g., extrude agent, glue, etc.) to a 3D region(s) indicated by the shape of the appendage(s). In some approaches (e.g., MJF), the 3D region(s) may be printed with fusing agent and fused using a thermal lamp to solidify the appendage(s). In some approaches (e.g., Metal Jet Fusion), the 3D region(s) may be printed with binding agent (e.g., glue) to form a precursor object (e.g., “green part”). The precursor object may be heated in an oven to solidify the appendage(s).

FIG. 6 is a block diagram of an example of an apparatus 602 that may be used to manufacture a structure or structures described herein. The apparatus 602 may be a computing device, such as a personal computer, a server computer, a printer, a 3D printer, a smartphone, a tablet computer, etc. The apparatus 602 may include and/or may be coupled to a processor 604, and/or to a memory 606. The processor 604 may be in electronic communication with the memory 606. In some examples, the apparatus 602 may be in communication with (e.g., coupled to, have a communication link with) an additive manufacturing device (e.g., a 3D printing device). In some examples, the apparatus 602 may be an example of a 3D printing device. The apparatus 602 may include additional components (not shown) and/or some of the components described herein may be removed and/or modified without departing from the scope of this disclosure.

The processor 604 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 606. The processor 604 may fetch, decode, and/or execute instructions (e.g., manufacturing instructions 618) stored in the memory 606. In some examples, the processor 604 may include an electronic circuit or circuits that include electronic components for performing a functionality or functionalities of the instructions (e.g., manufacturing instructions 618). In some examples, the processor 604 may be utilized to manufacture one, some, or all of the structures described in relation to one, some, or all of FIGS. 1-5.

The memory 606 may be any electronic, magnetic, optical, or other physical storage device that contains or stores electronic information (e.g., instructions and/or data). Thus, the memory 606 may be, for example, Random Access Memory (RAM), Electrically Erasable Programmable Read-Only Memory (EEPROM), a storage device, an optical disc, and the like. In some implementations, the memory 606 may be a non-transitory tangible machine-readable storage medium, where the term “non-transitory” does not encompass transitory propagating signals.

In some examples, the apparatus 602 may also include a data store (not shown) on which the processor 604 may store information. The data store may be volatile and/or non-volatile memory, such as Dynamic Random-Access Memory (DRAM), EEPROM, magnetoresistive random-access memory (MRAM), phase change RAM (PCRAM), memristor, flash memory, and the like. In some examples, the memory 606 may be included in the data store. In some examples, the memory 606 may be separate from the data store. In some approaches, the data store may store similar instructions and/or data as that stored by the memory 606. For example, the data store may be non-volatile memory and the memory 606 may be volatile memory.

In some examples, the apparatus 602 may include an input/output interface (not shown) through which the processor 604 may communicate with an external device or devices (not shown), for instance, to receive and/or store information pertaining to an object or objects (e.g., geometry(ies), lattice(s), appendage(s), etc.) to be manufactured. The input/output interface may include hardware and/or machine-readable instructions to enable the processor 604 to communicate with the external device or devices. The input/output interface may enable a wired and/or wireless connection to the external device or devices. In some examples, the input/output interface may further include a network interface card and/or may also include hardware and/or machine-readable instructions to enable the processor 604 to communicate with various input and/or output devices. Examples of input devices may include a keyboard, a mouse, a display, another apparatus, electronic device, computing device, etc., through which a user may input instructions into the apparatus 602. In some examples, the apparatus 602 may receive 3D model data 608 from an external device or devices (e.g., 3D scanner, removable storage, network device, etc.).

In some examples, the memory 606 may store 3D model data 608. The 3D model data 608 may be generated by the apparatus 602 and/or received from another device. Some examples of 3D model data 608 include a 3MF file or files, a 3D CAD image, object shape data, mesh data, geometry data, etc. The 3D model data 608 may indicate the shape of an object or objects. For instance, the 3D model data 608 may indicate the shape of a geometry or geometries (e.g., regular and/or irregular geometries) and/or a lattice or lattices for manufacture. In some examples, the 3D model data 608 may indicate a shape of one, some, or all of the geometry(ies), lattice(s), and/or appendage(s) described herein.

In some examples, the processor 604 may execute the manufacturing instructions 618 to control a printhead to print a 3D lattice of posts forming an opening between the posts. In some examples, the processor 604 may control a printhead to print a 3D lattice as described in relation to FIG. 5. For instance, the processor 604 may control a printhead and/or may send instructions to a 3D printer to print the 3D lattice.

In some examples, the processor 604 may execute the manufacturing instructions 618 to control the printhead to print an appendage attached to a post of the posts. In some examples, the appendage may extend over the opening. In some examples, the appendage may be non-load bearing. In some examples, the processor 604 may control a printhead to print an appendage as described in relation to FIG. 5. For instance, the processor 604 may control a printhead and/or may send instructions to a 3D printer to print the appendage(s).

In some examples, the post (with the attached appendage, for instance) may be an interior post. For instance, 3D printing may be utilized to print the appendage with the post during manufacturing to enable printing an appendage in the interior of the lattice.

In some examples, the processor 604 may execute the manufacturing instructions 618 to control the printhead to print a set of appendages attached to the 3D lattice. The set of appendages may depict information (e.g., a message). In some examples, the set of appendages may be printed in a color and/or shade that is different from other appendages.

Some examples of the techniques described herein may provide approaches to reduce and/or prevent the intake of foreign objects into open-foam lattice structures. Some examples of the techniques described herein may be relatively low-cost. In some examples, the appendages may not affect the mechanical properties of the lattice structures. In some examples, a pattern of the appendages may be used to carry additional information, such as patterns that signify a brand, patterns that are coded with a universally unique identifier, and/or other types of information that can be encoded with the appendage patterns.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A structure, comprising:
a lattice of posts forming an opening between the posts; and
an appendage attached to a post of the posts, wherein the appendage extends over the opening, and wherein the appendage is non-load bearing.

2. The structure of claim 1, wherein the appendage extends partially over the opening.

3. The structure of claim 1, wherein the post is an exterior post at an outer edge of the structure.

4. The structure of claim 3, further comprising:
an interior post; and
a second appendage attached to the interior post.

5. The structure of claim 4, wherein the appendage is attached to the exterior post at a first span position, and wherein the second appendage is attached to the interior post at a second span position that is different from the first span position.

6. The structure of claim 1, wherein the appendage is attached to the post at a center of a span between nodes of the post.

7. The structure of claim 1, wherein a size of the appendage does not deform when the structure is under a mechanical load.

8. The structure of claim 1, wherein the appendage is to reduce a size of the opening.

9. The structure of claim 1, wherein the structure is included in a midsole.

10. An apparatus, comprising:
a memory;
a processor in electronic communication with the memory, wherein the processor is to:
control a printhead to print a three-dimensional (3D) lattice of posts forming an opening between the posts; and
control the printhead to print an appendage attached to a post of the posts, wherein the appendage extends over the opening, and wherein the appendage is non-load bearing.

11. The apparatus of claim 10, wherein the post is an interior post.

12. The apparatus of claim 10, wherein the processor is to control the printhead to print a set of appendages attached to the 3D lattice, wherein the set of appendages depict a message.

13. A framework, comprising:
a lattice including a plurality of posts and a plurality of nodes at post intersections; and
an appendage extending over an opening between a first post and a second post of the plurality of posts, wherein the appendage is attached to the first post at a span between adjacent nodes of the plurality of nodes, and wherein an end of the appendage is unattached.

14. The framework of claim 13, wherein the framework is included in a midsole.

15. The framework of claim 13, wherein an outer edge of the framework is open.
